(19) United States
(12) Patent Application Publication
(10) Pub. No.: US 2010/0332086 A1
(43) Pub. Date: Dec. 30, 2010

(54) SYSTEM AND METHOD FOR AUTOMATICALLY OPENING VENTILATION GAPS IN WINDOWS AND CLOSING ALL WINDOWS OF A VEHICLE

(75) Inventor: Ruimin Zhao, Marietta, GA (US)

Correspondence Address: RUIMIN ZHAO, 3549 RIVER HEIGHTS XING, MARIETTA, GA, 30067, US

(73) Assignee: Ruimin Zhao, Marietta, GA (US)

(21) Appl. No.: 12/712,244

(22) Filed: Feb. 25, 2010

Related U.S. Application Data
(60) Provisional application No. 61/220,690, filed on Jun. 26, 2009.

(51) Int. Cl. G06F 19/00; B60J 7/043

(52) U.S. Cl. 701/49; 454/129

(57) ABSTRACT

The conventional power window system is augmented by two new automated routines: (a) setting each window to a slightly open position for ventilating the vehicle and (b) closing all windows. In one embodiment, two window control switches in the conventional power window system are designated as the first and second system control switches and, optionally, one button on a conventional remote vehicle door lock control is designated as the third system switch. A double-tap signal from the first system control switch triggers the first automated routine. A double-tap signal from the second or third system control switch triggers the first automated routine if all windows are closed and triggers the second automated routine if at least one window is not closed.

### CROSS-REFERENCE TO RELATED APPLICATIONS

This application claims priority to and the benefit of, pursuant to 35 USC §119(e), U.S. provisional patent application Ser. No. 61/220,690, filed Jun. 26, 2009, entitled “APPARATUS AND METHOD FOR AUTOMATICALLY OPENING VENTILATION GAPS IN WINDOWS AND CLOSING ALL WINDOWS OF VEHICLE” by Ruimin Zhao.

### FIELD AND BACKGROUND OF THE INVENTION

The present invention relates to power windows in automotive vehicles, and, more particularly, to automated operations of power windows in automotive vehicles.

Power windows have been widely used in automotive vehicles to facilitate the occupants' operation of the windows. A conventional power window system typically provides both manual operation and automated operation routines. One example of a manual operation is opening a window from its closed position to its partially open position. To perform this task, the operator would operate the control switch for lowering the window from its normal state to its active state and the window glass would start to move down. The operator would keep the switch in its active state until the window glass is lowered to the desired height. One example of an automated operation routine is the so-called “one-touch down” operation. To trigger it for a window that is programmed for this routine, the operator would move the control switch from its normal state to its active state and then immediately let the switch return to its normal state. Once the power window system receives the one-touch signal, it will execute the automated operation routine of lowering the window glass all the way to the bottom.

When a vehicle is parked in direct sun light in hot weather, people often elect to leave the vehicle windows slightly open, forming gaps for ventilating the vehicle so that the interior can be cooler. The conventional power window system does not offer any automated operation routines for setting windows to their ventilation gap positions. As a result, manual operations have to be used for that purpose. It is an inconvenient, trial-and-error process to set each of the windows of the vehicle to its ventilation gap position.

### SUMMARY OF THE INVENTION

In accordance with the invention, the problem of the inconvenience with the conventional power window system when setting the windows to ventilation gap positions is solved by augmenting the system with two new automated operation routines and convenient means to trigger them. The first new automated operation routine, hereafter referred to as Routine 1, is to set each window in the power window system to its ventilation gap position. The second new automated operation routine, hereafter referred to as Routine 2, is to close all windows in the system. The size of each ventilation gap should be just small enough to prevent human hands from reaching the vehicle controls inside the vehicle.

In the two embodiments described in this application, the power window control system triggers Routine 1 and Routine 2 by double-tap signals from a set of system control switches. Each of the system control switches has a normal state and an active state. A double-tap signal from a switch is generated when, within a predetermined length of time, the switch twice changes from its normal state to its active state. Using double-tap signals for triggering the routines allows the invention to be implemented by extending the function of the existing switches in the conventional vehicle body control system, hence eliminating the requirement for any new hardware.

In both of the embodiments, a pair of switches (usually combined into one lever-operated device) in the conventional power window system that the vehicle driver uses to control one window are designated as the first and second system control switches. The switch for lowering the window glass in the conventional power window system is designated as the first system control switch and the switch for raising the window glass in the same system is designated as the second system control switch.

In the first embodiment, a double-tap signal from the first system control switch triggers Routine 1 and a double-tap signal from the second system control switch triggers Routine 2.

In the second embodiment, a double-tap signal from the first system control switch triggers Routine 1. A double-tap signal from the second system control switch triggers Routine 1 if all of the windows are closed. Otherwise, the same double-tap signal triggers Routine 2. Furthermore, a push button switch on a remote door control device conventionally used for locking all of the doors of the vehicle is designated as the third system control switch and it functions the same as the second system control switch when double-tap signals are generated.

These and other aspects of the present invention will become apparent from the following description of the embodiments taken in conjunction with the following drawings, although variations and modifications therein may be affected without departing from the spirit and scope of the novel concepts of this disclosure.

### DRAWING FIGURES

FIG. 1 shows the system components of the first embodiment.

FIG. 2 is a flowchart of the power window control system in the first embodiment.

FIG. 3 is a flowchart of Routine 1 in the first embodiment.

FIG. 4 shows the system components of the second embodiment.

FIG. 5 is a flowchart of the power window control system in the second embodiment.

FIG. 6 is a flowchart of the process that tracks the down moves of the window glass that might be of use for Routine 1 in the second embodiment.

FIG. 7 is a flowchart of Routine 1 in the second embodiment.

### DETAILED DESCRIPTION OF THE EMBODIMENTS

With reference to the accompanying drawings, the present invention will hereinafter be described in order for those skilled in the art to be able to implement the invention. As those skilled in the art would realize, the described embodiments may be modified in various different ways, all without departing from the spirit or scope of the present invention.

### DESCRIPTIONS

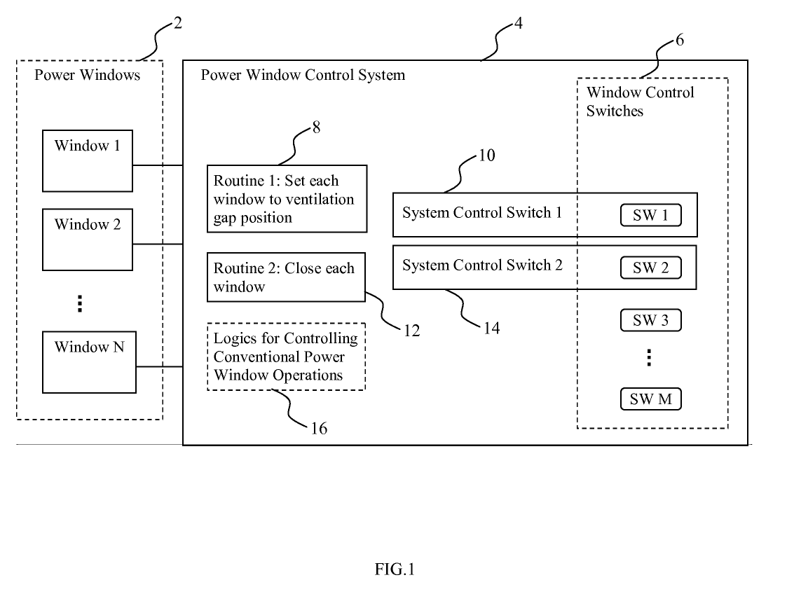

### FIGS. 1, 2, 3—Embodiment I

FIG. 1 shows the system components of the first embodiment. As shown in the figure, this embodiment consists of two main component groups: (a) a plurality of power windows 2 and (b) a power window control system 4. The plurality of power windows are labeled as Windows 1 through N. The power window control system comprises a plurality of window control switches 6 and logics for controlling conventional power window operations 16. These control switches and control logics are part of a conventional power window system. In this embodiment of the invention, two window control switches for conventionally controlling one power window are designated as the first and second system control switches 10, 14. The first system control switch is the window control switch conventionally for lowering the window glass, and the second system control switch is the window control switch conventionally for raising the window glass. The power window control system also comprises two automated routines that a conventional power window system does not have. These routines are Routine 1, setting each of the windows to its ventilation gap position 8, and Routine 2, closing each of the windows 12.

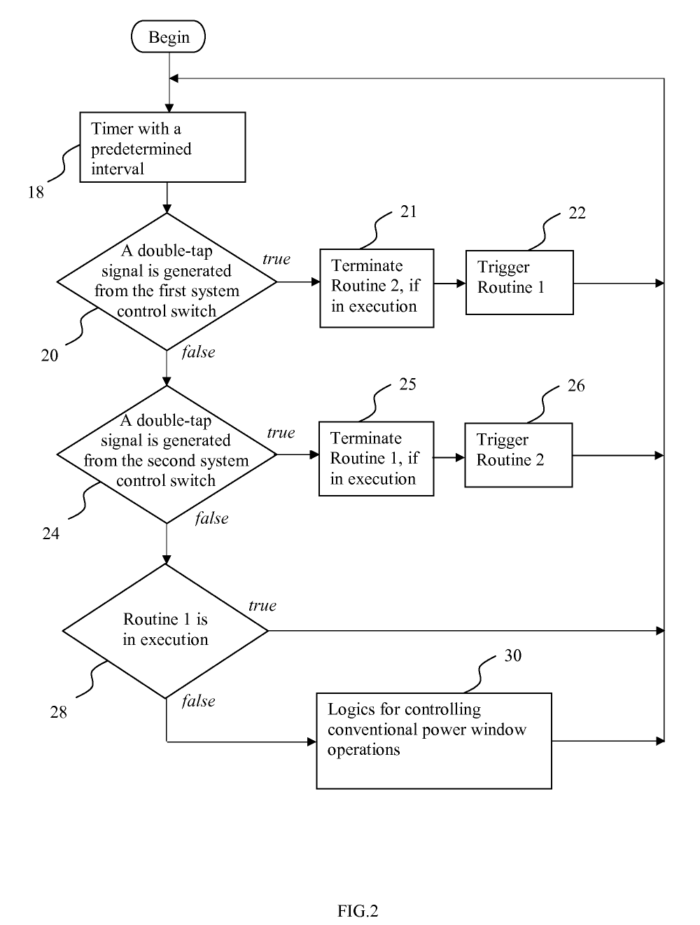

FIG. 2 is a flowchart of the power window control system in the first embodiment. Block 18 is a timer with a predetermined interval. In every amount of time equal to the interval, the timer triggers the execution of the core part of the window control process (20 through 30). The timer's interval is larger than the time needed to execute the control process consisting of blocks 20 through 30.

Block 20 tests if a double-tap signal has been generated from the first system control switch. If the test result is true, Routine 2 is terminated if it is still in execution 21 and Routine 1 is triggered 22. Otherwise, block 24 tests if a double-tap signal has been generated from the second system control switch. If the test result is true, Routine 1 is terminated if it is still in execution 25 and Routine 2 is triggered 26. Otherwise, block 28 tests if Routine 1 is in execution. If the test result is false, the logics for controlling conventional power window operations 30 are executed. After block 22, block 26, or block 30 is executed, or block 28 yields a true value, system control is handed back to the timer 18, waiting for the timer to trigger at the next time point. Although Routine 1 cannot be overridden by conventional power window operations, the effect of Routine 2 on an individual window can be overridden by conventional power operations of that window by the logics for controlling conventional power window operations 30.

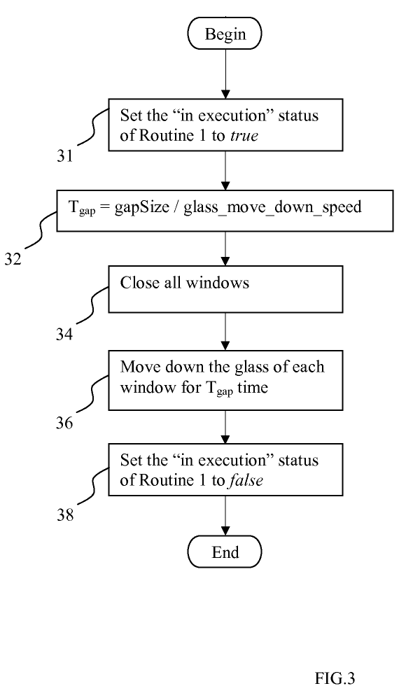

FIG. 3 is a flowchart of Routine 1 in the first embodiment. Block 31 sets the “in execution” status of Routine 1 to true. Block 32 calculates the T_{gap} value, which is the time needed for opening the ventilation gap for each window from its closed position. The parameter gapSize is the size of the ventilation gap, which is predetermined and is just small enough to prevent human hands from reaching the vehicle controls inside the vehicle's cabin. The usual range of the gap is from 1 inch to 1.5 inches. The glass_move_down_speed parameter is the rate at which the window glass moves down when powered to do so.

Block 34 is the routine of closing all windows of the vehicle. After that is done, each window glass is powered to go down for the time length of T_{gap} 36. Then, the “in execution” status of Routine 1 is set to false 38.

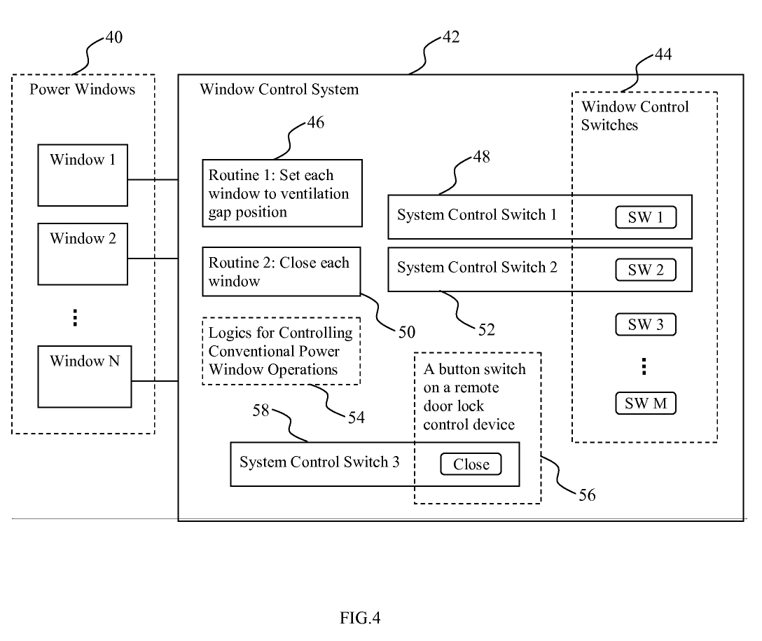

### FIGS. 4, 5, 6, 7—The Preferred Embodiment II

In the first embodiment, when Routine 1 is triggered from the closed position of the window glass that is conventionally controlled by the first and second system control switches, the glass will go through the following phases:
(1) Moving down as a conventional manual move, triggered by the first change from the normal state to the active state of the first system control switch.
(2) Moving down as a conventional, automated, one-touch down move, triggered by the first change from the active state to the normal state of the first system control switch.
(3) Moving up after the second change from the normal state to the active state of the first system control switch, until the top position is reached, as block 34 of FIG. 3 is being executed.
(4) Moving down until the ventilation gap position is reached, as block 36 of FIG. 3 is being executed.
   Since the two switch state changes from normal to active have to happen within a predetermined time length to generate a double-tap signal, which will trigger Routine 1, Phases 1 and 2 will result in a gap in the window that is smaller than the ventilation gap. In this case, Phase 3 can be annoying because the movement in the opposite direction to the ventilation gap position can be seen as totally unnecessary.

The second, and preferred, embodiment uses a more sophisticated control logic to eliminate Phase 3. It also adds the following features: (a) when all windows are closed, a double-tap signal from the second system control switch will trigger Routine 1; and (b) a button switch on the vehicle's remote door lock control for locking the doors is designated as the third system control switch and a double-tap signal from this switch has the same effect as that from the second system control switch.

FIG. 4 shows the system components of the second embodiment. Compared to the first embodiment, the second embodiment has one additional component: a button switch on a remote door lock control device 56. It is designated as the third system control switch 58.

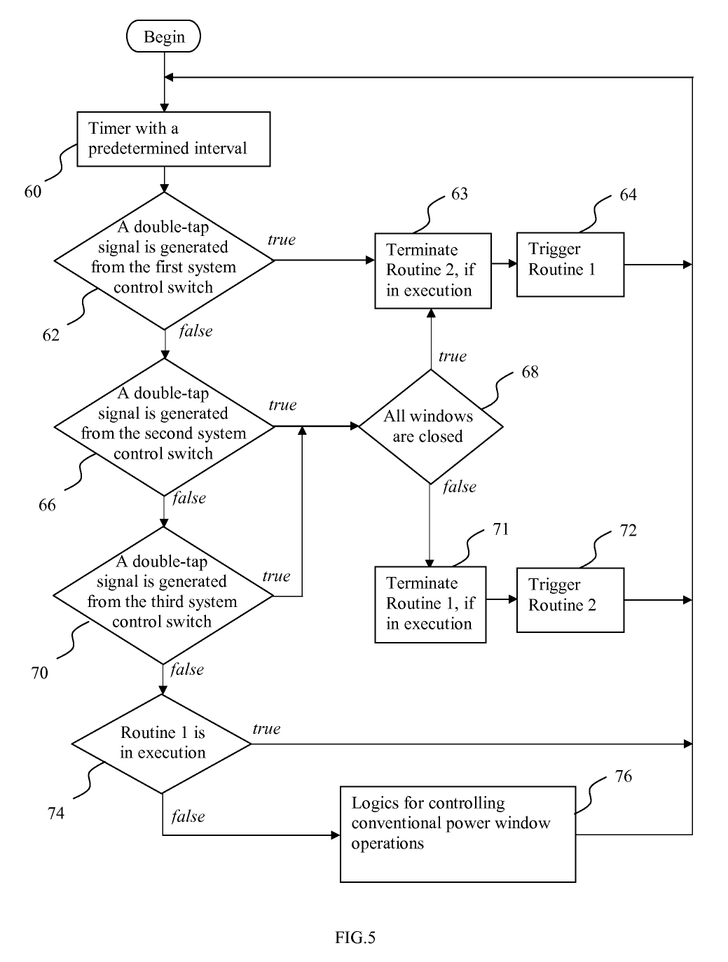

FIG. 5 is a flowchart of the power window control system in the second embodiment. Blocks 68 and 70 are responsible for the aforementioned new features (a) and (b).

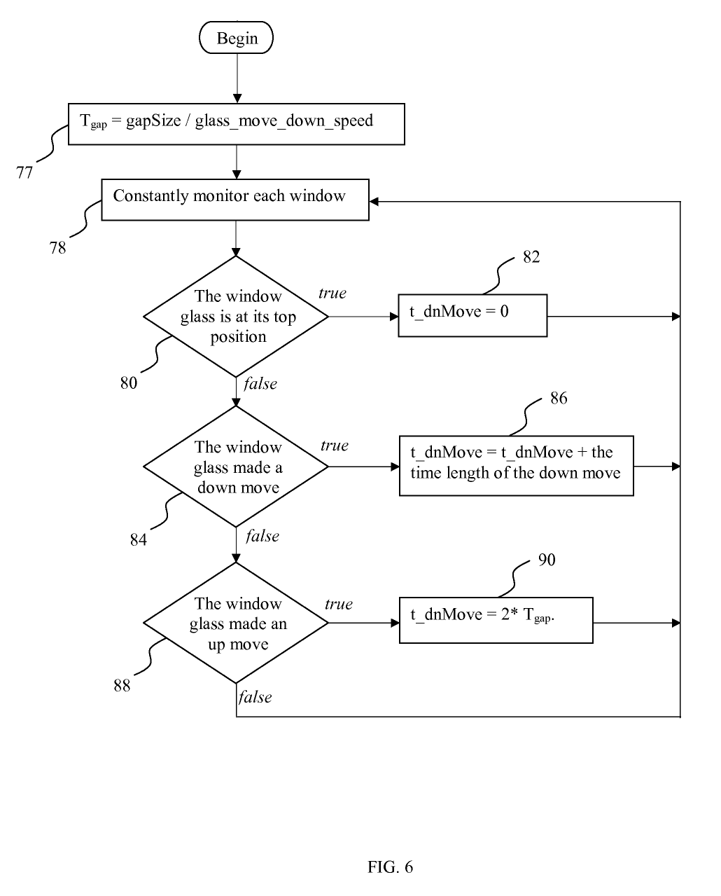

FIG. 6 is a flowchart of the process of tracking the window glass down moves that might be of use for Routine 1 in the second embodiment. Block 77 calculates the T_{gap} value, which is the time needed for opening the ventilation gap for each window from its closed position. The parameter gapSize is the size of the ventilation gap, which is predetermined and is just small enough to prevent human hands from reaching the vehicle controls inside the vehicle's cabin. The usual range of the gap is from 1 inch to 1.5 inches. The glass_move_down_speed parameter is the rate at which the window glass moves down when powered to do so.

After the T_{gap} value is obtained, each window is constantly monitored 78. If a window glass is detected at its top position 80, the variable t_dnMove is set to 0 (82). This variable is used to track the cumulative down moves that might be used in Routine 1 for eliminating unnecessary up moves for closing the window. If block 80 does not detect a top position of the glass, block 83 tests if the glass has just made a down move. If the result is true, block 86 is executed to track the cumulative down moves. Otherwise, a test is done to see if the glass has just made an up move 88. If such a move is detected, block 90 sets the tracking variable t_dnMove to a value that is larger than T_{gap}. A t_dnMove value larger than T_{gap} tells Routine 1 that there are no cumulative down moves that can be built upon when opening the ventilation gap.

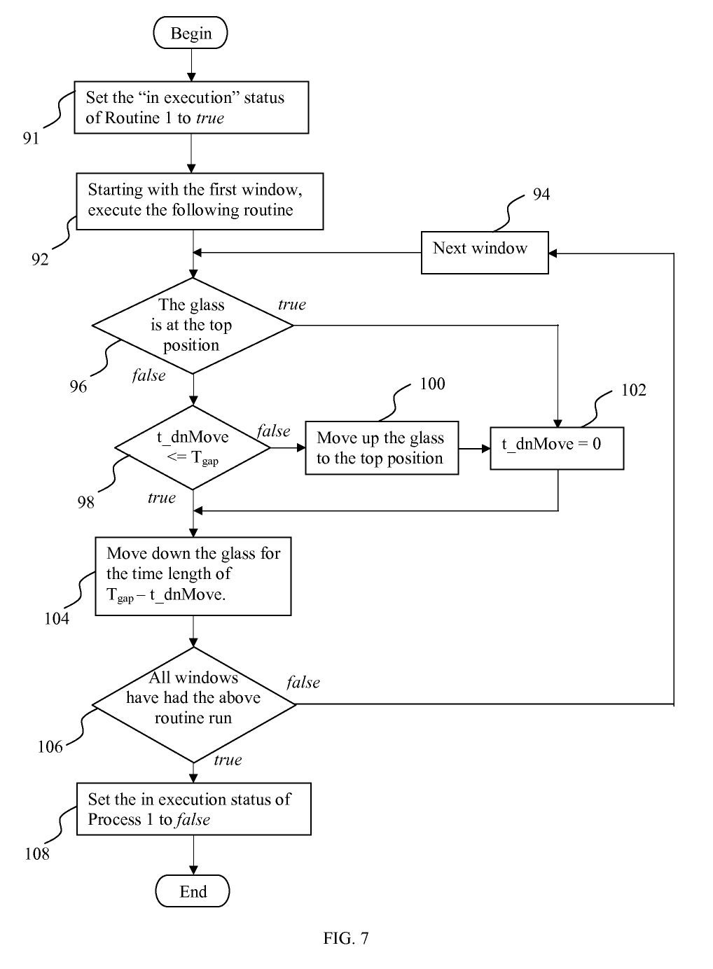

FIG. 7 is a flowchart of Routine 1 in the second embodiment. The routine uses the t_dnMove value tracked by the process of FIG. 6 for eliminating some of the unnecessary up moves of the window glass. Block 91 sets the “in execution” status of Routine 1 to true. Blocks 92, 94, and 106 implement a loop through all windows in the power window system. For each window, block 96 tests if the glass is at the top position. If true, the variable t_dnMove is set to 0 (102), indicating that no cumulative down move can be built upon. If the glass is not at the top position, a test 98 is performed to see if the t_dnMove value is equal to or smaller than T_{gap}, which is the time length needed to move the glass from the top position to the ventilation gap position. If the result is false, the t_dnMove value is ignored and the routine of closing the window 100 is executed. In the next step, the variable t_dnMove is set to 0 (102). If the test result from block 98 is true, t_dnMove has a valid value to be built upon in moving the window glass to its ventilation gap position. The next step is to move down the glass for the remaining time needed to set the glass to the ventilation gap position 104. After the process of blocks 96 through 104 is executed for all of the windows, the “in execution” status of Routine 1 is set to false 108.

### ADVANTAGES

The following are the advantages of the present invention:

(a) Vehicle drivers can conveniently open window gaps for ventilation by using simple actions on an existing window control switch or on a button on the door lock remote control.

(b) The ventilation gaps will be very useful for keeping vehicle cabins cooler when the vehicles are parked in direct sunlight in hot weather.

(c) The drivers can conveniently close all windows.

(d) The cost of implementing the invention will be low because no new hardware devices are needed.

(e) The present invention can even be implemented in vehicles already in service by modifying the software of the vehicles' body controller.

### CONCLUSION, RAMIFICATIONS, AND SCOPE

The present invention describes a system and method for automatically opening ventilation gaps in the power windows of vehicles and closing all of the windows. The signals for triggering these automated routines are conveniently generated by using double-tap actions on two window control switches that are already in the conventional power window system. In addition, the signals can also be generated from a button on the vehicle door lock remote control. The ventilation gaps will be very useful for keeping the vehicle cabins cooler when the vehicles are parked in direct sunlight in hot weather. The size of the ventilation gaps will be in the range of 1 inch to 1.5 inches. It should be just small enough to prevent human hands from reaching the vehicle controls inside the cabin.

Although the description above contains many specificities, these should not be construed as limiting the scope of the invention. Instead, they merely provide illustrations of some embodiments of the invention. Ramifications can include, but are not limited to, the following:

(a) The system can include one or two power roof windows. The ventilation gap position of a roof window is its tilted-up open position or slide open gap position.

(b) The system can use dedicated switches as the system control switches. When using dedicated switches, a routine triggering signal from such a switch can be defined as the event when the switch is operated from its normal state to its active state.

(c) In the two embodiments disclosed in this application, the routine of setting one window to its ventilation gap position essentially has two phases: (1) raising the window glass to its fully closed position and (2) lowering it for a calculated time period so that it will stop close to the designated ventilation gap position. If the power window system has a way of providing reliable information about the window glass position all the time, the same routine can be executed in a more straightforward way. The window glass can be directly moved to the ventilation gap position from any possible previous position.

(d) The processes depicted in FIG. 6 and FIG. 7 can be changed to track and use up moves of window glasses when driving motors can be accurately controlled.

(e) The system can include an environmental sensor such as a rain detector, a photo sensor, or a thermal sensor for triggering the routine of closing all windows.

Thus, the scope of the invention should be determined by the appended claims and their legal equivalents, rather than by the example given.

I claim:

1. A power window system used in a vehicle, comprising:
(a) a plurality of power windows, including one or more vertical power windows and zero or more roof windows, and
(b) a window control system comprising a first operation routine and one or more means for triggering the first operation routine, the first operation routine being setting each power window to its ventilation gap position, the ventilation gap position for a vertical window being for the window to be slightly open, leaving a gap of a predetermined size for ventilating the vehicle, and the ventilation gap position for a roof window being for the window to be tilted up or to be slid away from the closed position to form a gap of a predetermined size for ventilating the vehicle.

2. The power window system as claimed in claim 1, wherein the window control system further comprises a second operation routine and one or more triggering means for the second operation routine, the second operation routine being closing all of the power windows.

3. The power window system as claimed in claim 1, wherein one means for triggering the first operation routine comprises:
(a) a control switch located inside the vehicle or on a remote control device, the control switch having a normal state and an active state, and
(b) machine instructions to trigger the first operation routine when the control switch changes from its normal state to its active state.

4. The power window system as claimed in claim 1, wherein one means for triggering the first operation routine comprises:
(a) a control switch located inside the vehicle or on a remote control device, the control switch having a normal state and an active state, and
(b) machine instructions to trigger the first operation routine when, within a predetermined length of time, the control switch twice changes from its normal state to its active state.

5. The power window system as claimed in claim 2, wherein the means for triggering the first and second operation routines comprise:
(a) a control switch located inside the vehicle or on a remote control device, the control switch having a normal state and an active state, and
(b) machine instructions to trigger the second operation routine when the control switch changes from its normal state to its active state while not all of the power windows are closed.

6. The power window system as claimed in claim 5, further comprising machine instructions to trigger the first operation routine when the control switch changes from its normal state to its active state while all of the power windows are closed.

7. The power window system as claimed in claim 2, wherein the means for triggering the first and second operation routines comprise:
(a) a control switch located inside the vehicle or on a remote control device, the control switch having a normal state and an active state, and
(b) machine instructions to trigger the second operation routine when, within a predetermined length of time, the control switch twice changes from its normal state to its active state while not all of the power windows are closed.

8. The power window system as claimed in claim 7, further comprising machine instructions to trigger the first operation routine when, within a predetermined length of time, the control switch twice changes from its normal state to its active state while all of the power windows are closed.

9. The power window system as claimed in claim 2, wherein one means for triggering the second operation routine comprises:
(a) a rain detector, and
(b) machine instructions to trigger the second operation routine when the rain detector detects rain.

10. The power window system as claimed in claim 2, wherein one means for triggering the second operation routine comprises:
(a) a photo sensor, and
(b) machine instructions to trigger the second operation routine when the photo sensor detects an ambient light level being below a predetermined threshold level.

11. The power window system as claimed in claim 2, wherein one means for triggering the second operation routine comprises:
(a) a thermal sensor, and
(b) machine instructions to trigger the second operation routine when the thermal sensor detects a temperature being below a predetermined temperature.

12. A method for controlling a plurality of power windows in a vehicle, the plurality of power windows including one or more vertical power windows and zero or more roof windows, the method comprising:
(a) setting each of the plurality of power windows to its ventilation gap position when a signal of the first type is generated, the ventilation gap position for a vertical window being for the window to be slightly open, leaving a gap of a predetermined size for ventilating the vehicle, and the ventilation gap position for a roof window being for the window to be tilted up or to be slid away from the closed position to form a gap of a predetermined size for ventilating the vehicle, and
(b) one or more methods of generating signals of the first type.

13. The method as claimed in claim 12, further comprising:
(a) closing all of the power windows when a signal of the second type is generated, and
(b) one or more methods of generating signals of the second type.

14. The method as claimed in claim 12, wherein one method for generating signals of the first type comprises:
(a) providing a control switch located inside the vehicle or on a remote control device, the control switch having a normal state and an active state, and
(b) generating a signal of the first type when the control switch changes from its normal state to its active state.

15. The method as claimed in claim 12, wherein one method for generating signals of the first type comprises:
(a) providing a control switch located inside the vehicle or on a remote control device, the control switch having a normal state and an active state, and
(b) generating a signal of the first type when, within a predetermined length of time, the control switch twice changes from its normal state to its active state.

16. The method as claimed in claim 13, wherein the methods for generating signals of the first and second types comprise:
(a) providing a control switch located inside the vehicle or on a remote control device, the control switch having a normal state and an active state, and
(b) generating a signal of the second type when the control switch changes from its normal state to its active state while not all of the power windows are closed.

17. The method as claimed in claim 16, further comprising: generating a signal of the first type when the control switch changes from its normal state to its active state while all of the power windows are closed.

18. The method as claimed in claim 13, wherein the methods for generating signals of the first and second types comprise:
(a) providing a control switch located inside the vehicle or on a remote control device, the control switch having a normal state and an active state, and
(b) generating a signal of the second type when, within a predetermined length of time, the control switch twice changes from its normal state to its active state while not all of the power windows are closed.

19. The method as claimed in claim 18, further comprising: generating a signal of the first type when, within a predetermined length of time, the control switch twice changes from its normal state to its active state while all of the power windows are closed.

20. The method as claimed in claim 13, wherein one method for generating signals of the second type comprises:
(a) providing a rain detector, and
(b) generating a signal of the second type when the rain detector detects rain.

21. The method as claimed in claim 13, wherein one method for generating signals of the second type comprises:
(a) providing a photo sensor, and
(b) generating a signal of the second type when the photo sensor detects an ambient light level being below a predetermined threshold level.

22. The method as claimed in claim 13, wherein one method for generating signals of the second type comprises:
(a) providing a thermal sensor, and
(b) generating a signal of the second type when the thermal sensor detects a temperature being below a predetermined temperature.
